(19) United States
(12) Patent Application Publication
(10) Pub. No.: US 2020/0134673 A1
(43) Pub. Date: Apr. 30, 2020

(54) INFORMATION PROCESSING APPARATUS AND INFORMATION PROCESSING METHOD

(71) Applicants: TOYOTA JIDOSHA KABUSHIKI KAISHA, Toyota-shi (JP); DENSO CORPORATION, Kariya-city (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Kariya-city (JP); Kuniaki JINNAI, Nagoya-shi (JP)

(73) Assignees: TOYOTA JIDOSHA KABUSHIKI KAISHA, Toyota-shi (JP); DENSO CORPORATION, Kariya-city (JP)

(21) Appl. No.: 16/656,776

(22) Filed: Oct. 18, 2019

(30) Foreign Application Priority Data
Oct. 24, 2018 (JP) 2018-200188

(51) Int. Cl. G06Q 30/02; G09F 21/04

(52) U.S. Cl. CPC G06Q 30/0266; G09F 21/048

(57) ABSTRACT

An information processing apparatus includes a control unit configured to execute the processing of acquiring information relating to the circumstances of travelling of a vehicle that is capable of outputting an advertisement by a display apparatus arranged to face outward, determining the amount of information of the advertisement to be output on the basis of the circumstances of travelling, and selecting the advertisement to be output to the display apparatus on the basis of the amount of information thus determined.

### CROSS REFERENCE TO THE RELATED APPLICATION

This application claims the benefit of Japanese Patent Application No. 2018-200188, filed on Oct. 24, 2018, which is hereby incorporated by reference herein in its entirety.

### BACKGROUND

### Technical Field

The present disclosure relates to technologies of providing advertisements using vehicles as media.

### Description of the Related Art

Advertising using vehicles as media has been developed in recent years. For example, an outside display apparatus is provided on a vehicle to display advertisements. The advertisement to be displayed dynamically selected appropriately according to circumstances to optimize the effectiveness of advertising.

### CITATION LIST

### Patent Literature

Patent Literature 1: Japanese Patent Application Laid-Open No. 2004-361661

### SUMMARY

To enhance the effectiveness of advertisements displayed using vehicles as media, it is desirable that appropriate types of advertisement that are suitable for circumstances of travel of the vehicles be displayed.

The present disclosure has been made in the above circumstances, and an object of the present disclosure is to enhance the effectiveness of advertisements that are displayed using vehicles as media.

An information processing apparatus according to a first aspect of the present disclosure comprises a control unit configured to execute the processing of acquiring information relating to the circumstances of travelling of a vehicle that is capable of outputting an advertisement by a display apparatus arranged to face outward, determining the amount of information of the advertisement to be output on the basis of the circumstances of travelling, and selecting the advertisement to be output to the display apparatus on the basis of the amount of information thus determined.

An information processing method according to a second aspect of the present disclosure comprises the following steps executed by an information processing apparatus: acquiring information relating to the circumstances of travelling of a vehicle that is capable of outputting an advertisement by a display apparatus arranged to face outward; determining the amount of information of the advertisement to be output on the basis of the circumstances of travelling; and selecting the advertisement to be output to the display apparatus on the basis of the amount of information thus determined.

According to a third aspect of the present disclosure, there is provided a program that causes a computer to implement the above-described information processing method or a computer-readable recording medium in which the program is stored in a non-transitory manner.

The present disclosure can enhance the effectiveness of advertisements that are displayed using vehicles as media.

### BRIEF DESCRIPTION OF THE DRAWINGS

FIG. 1 is a diagram illustrating the general configuration of an advertisement distribution system according to an embodiment.

FIG. 2 is a diagram illustrating the system configuration of a vehicle 10 according to a first embodiment.

FIG. 3 illustrates the positions of display apparatuses provided on vehicles 10.

FIG. 4 is a diagram illustrating the system configuration of a server apparatus 20 according to the first embodiment.

FIG. 5 shows an example of an advertisement information table stored in a database.

FIGS. 6A to 6C are diagrams illustrating variations of the amount of information of advertisements.

FIG. 7 shows an example of a vehicle information table stored in a database.

FIG. 8 shows an example of a travel record table stored in a database.

FIG. 9 is a flow chart of a process executed by the server apparatus 20.

FIG. 10 is a flow chart of a first process executed by the vehicle 10.

FIG. 11 is a flow chart of a second process executed by the vehicle 10.

FIG. 12 shows an example of an information amount table.

FIG. 13 shows a modification of the information amount table.

FIG. 14 shows a modification of the advertisement information table.

### DESCRIPTION OF THE EMBODIMENTS

An advertisement distribution system according to the present disclosure includes a server apparatus and a plurality of vehicles. The server apparatus distributes advertisements to the plurality of vehicles, and each vehicle displays an advertisement on its display apparatus that faces outward. Each vehicle in the system outputs an advertisement (in the form of a still or moving image) it has received from the server apparatus by the outside display apparatuses provided on the vehicle body while it is travelling.

It is desirable for the system that uses moving advertising medium to distribute advertisements that are as easy as possible for the viewers to grasp. However, simplifying the content of advertising to this end can lead to deficient understanding by the viewers of messages that the advertiser wants to deliver.

In view of the above circumstances, the information processing apparatus according to the present disclosure is configured to acquire information about the circumstances of travelling of a vehicle that provides an advertisement and determine the amount of information of the advertisement to be provided on the basis of the circumstances of travelling. Moreover, the information processing apparatus is configured to select the advertisement to be output to the display apparatus on the basis of the amount of information determined as above.

The circumstances of travelling may be any circumstances that are relevant to the visibility of the advertisement displayed by the vehicle, which may be circumstances relating to the speed of the vehicle or circumstances relating to the traffic around the vehicle. The circumstances of travelling may be determined using sensor data acquired by the vehicle.

Since the amount of information of the advertisement to be displayed is determined on the basis of the circumstances of travelling, the information processing apparatus can cause the vehicle to display, for example, a simple advertisement under circumstances in which the advertisement can be viewed only for a short time (e.g. when the vehicle speed is high) and a complex advertisement under circumstances in which the advertisement can be viewed for a relatively long time (e.g. when the vehicle is waiting for the traffic light to change).

When selecting an advertisement on the basis of the amount of information determined as above, the information processing apparatus may select an appropriate advertisement from among a plurality of different advertisements or an appropriate version of advertisement if a plurality of versions of the same advertisement that have different amounts of information are available.

The circumstances of travelling may include at least one of the speed of the vehicle, the presence of another vehicle in the vicinity of the aforementioned vehicle, and the length of time over which the aforementioned vehicle is expected to stop in a certain period of time. The visibility of the advertisement can be estimated from these factors.

The advertisement may comprise a moving image, and the control unit may determine the amount of information of the moving image to be output per unit time on the basis of the circumstances of travelling. For example, the lower the visibility of the advertisement is, the simpler the moving image to be displayed may be, in other words the smaller the amount of information per unit time of the moving image may be.

The advertisement may comprise a moving image, and the control unit may determine the duration of the moving image to be output on the basis of the circumstances of travelling. For example, the lower the visibility of the advertisement is, the shorter the moving image of the advertisement to be displayed may be.

The advertisement may comprise a still image, and the control unit may determine the number of words contained in the still image to be output. For example, the lower the visibility of the advertisement is, the smaller the number of words contained in the image of the advertisement may be made.

In the following, specific embodiments of the present disclosure will be described with reference to the drawings. It should be understood that features such as hardware configurations, module configurations, and functional configurations that will be described in connection with the embodiment are not intended to limit the technical scope of the present disclosure only to them, unless otherwise stated.

### First Embodiment

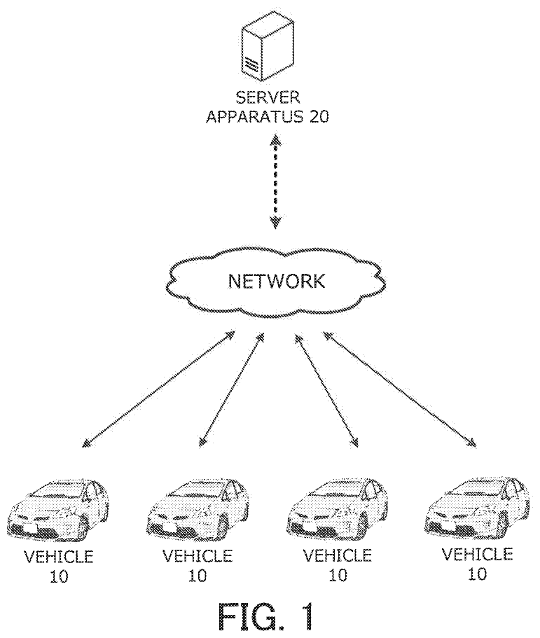

FIG. 1 is a diagram illustrating the general configuration of an advertisement distribution system according to a first embodiment. The advertisement distribution system according to the first embodiment includes a plurality of vehicles 10 and a server apparatus 20.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10. In the following description of the embodiment, the term “users” will be used to refer to an intended audience of an advertisement output by the vehicles 10.

The vehicle 10 receives advertisement data from the server apparatus 20 and outputs an advertisement to the display apparatuses while it is travelling. The vehicle 10 periodically sends information about the state of display of an advertisement (e.g. location information and information identifying the advertisement displayed) to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

Advertisements distributed to the vehicles 10 each include a plurality of versions that have different amounts of information, and each vehicle 10 selects an appropriate version of advertisement that is suitable for the circumstances of travelling and outputs it. Thus, the vehicle can display a simple advertisement with a small amount of information in circumstances in which the visibility of the advertisement is low and an advertisement with a larger amount of information in circumstances in which the visibility of the advertisement is high.

The vehicles 10 and the server apparatus 20 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, and other wireless communication networks, such as Wi-Fi (registered trademark).

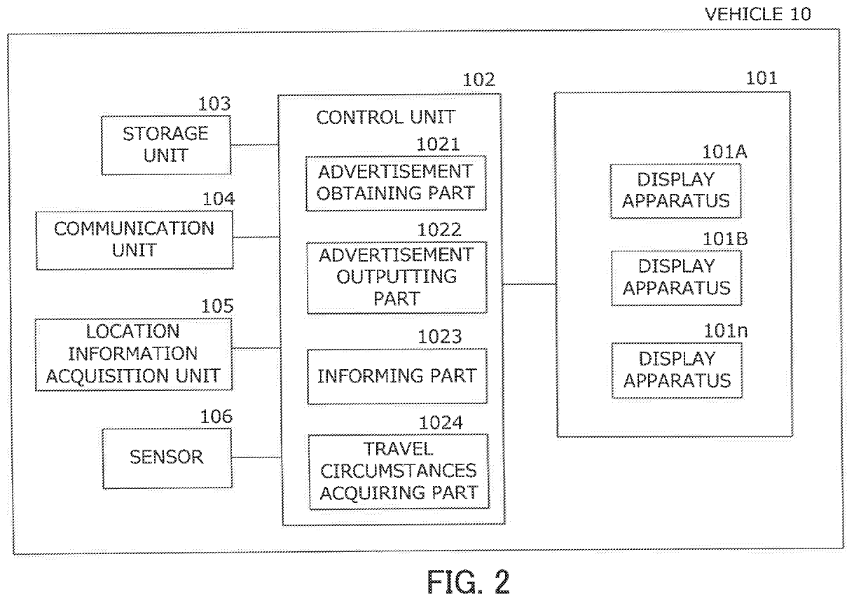

Now, the configuration of the vehicle 10 will be described. FIG. 2 is a diagram illustrating the system configuration of the vehicle 10.

The vehicle 10 includes a display unit 101, a control unit 102, a storage unit 103, a communication unit 104, a location information acquisition unit 105, and a sensor 106.

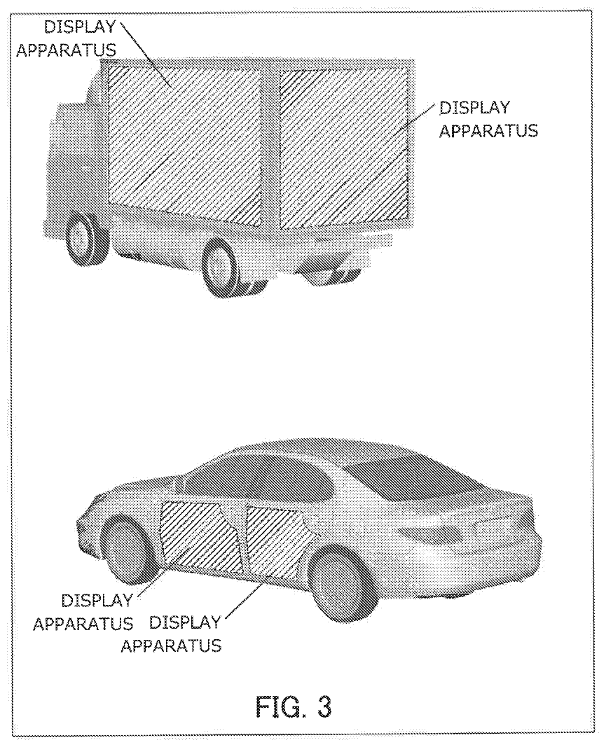

The display apparatus 101 includes a plurality of display apparatuses provided on the outside of the vehicle 10. As illustrated in FIG. 3, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side

Display apparatuses 101 may be provided at positions other than those described above. For example, if it is possible to project images on a sheet of glass, display apparatuses may be provided on windows (e.g. side and rear windows).

The control unit 102 is a computing device that controls the function of outputting advertisements among the functions of the vehicle 10. The control unit 102 may be implemented by a computational processing unit, such as a CPU (Central Processing Unit).

The control unit 102 includes four functional modules, which include an advertisement obtaining part 1021, an advertisement outputting part 1022, an informing part 1023, and a travel circumstances acquiring part 1024. These functional modules may be implemented by executing programs stored in the storage unit 103 (described later) by a CPU.

The advertisement obtaining part 1021 obtains data (or advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an image or the like contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The informing part 1023 sends information about display of an advertisement to the server apparatus 20. Specifically, the informing part 1023 collects information about the present location of the vehicle, identification data of the advertisement presently displayed, and other information relating to the advertisement and sends them to the server apparatus 20.

The travel circumstances acquiring part 1024 acquires information about the circumstances of travelling. The circumstances of travelling refer to factors that affect the visibility of the advertisement displayed by the vehicle 10. For example, the visibility might be lower when the speed or average speed of the vehicle is high than when the speed or average speed is low. The speed or average speed of the vehicle 10 changes depending on the traffic around it. For example, a traffic jam around the vehicle 10 lowers the average speed of the vehicle 10, making the visibility of the advertisement higher. Frequent waiting at traffic lights also lowers the average speed, making the visibility of the advertisement higher.

The travel circumstances acquiring part 1024 calculates an evaluation value that evaluates factors that affect the visibility of the advertisement, such as the vehicle speed, the degree of traffic congestion, stopping at a traffic signal, and the duration of red traffic light. The evaluation value thus calculated is sent to the advertisement outputting part 1022 and used in selecting an advertisement to be displayed.

Details of processing executed by each module will be described later.

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unfit configured to acquire location information of the vehicle 10. The location information acquisition unit 105 includes, for example, a GPS module and acquires location information (e.g. latitude and longitude) of the vehicle 10.

The sensor 106 refers to a group of sensors provided on the vehicle 10. The sensor 106 may include one or more sensors that acquire a physical quantity relating to the speed or average speed as sensor data. Examples of such sensors include a vehicle speed sensor and a distance sensor. Sensor data output from the sensor 106 is sent to the travel circumstances acquiring part 1024. The sensor 106 is not necessarily one that measures a certain physical quantity. For example, the sensor 106 may obtain data relating to the degree of traffic congestion in the vicinity of the vehicle 10, data of the speeds of other vehicles present around the vehicle 10, and/or data relating to control of traffic signals, by road-to-vehicle communication or inter-vehicle communication. In the description of this embodiment, such data will also be referred to as sensor data.

FIG. 2 is given only to illustrate an exemplary configuration, and all or some of the functions shown in FIG. 2 may be implemented by circuits dedicated to the functions. Main and auxiliary storage devices other than those illustrated may be employed in combination to store and/or execute programs.

Next, the configuration of the server apparatus 20 will be described.

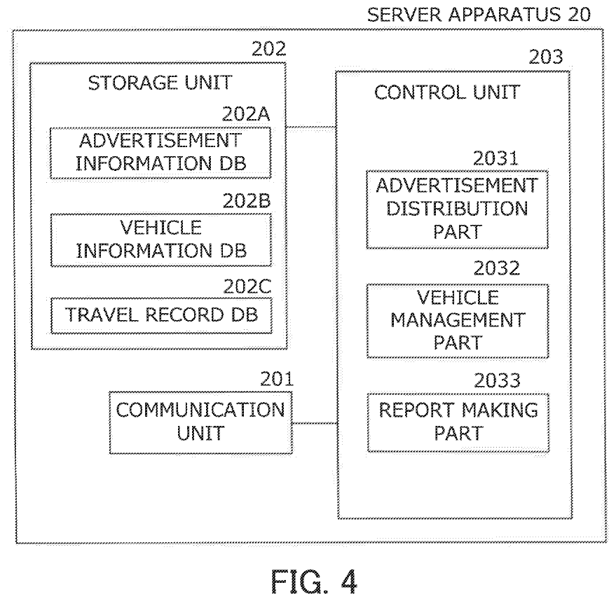

FIG. 4 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will he described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record database 202C.

The advertisement information database 202A is a database in which data relating to advertisements to be distributed to the vehicles 10 is stored. Such data is created by an advertiser(s).

The vehicle information database 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

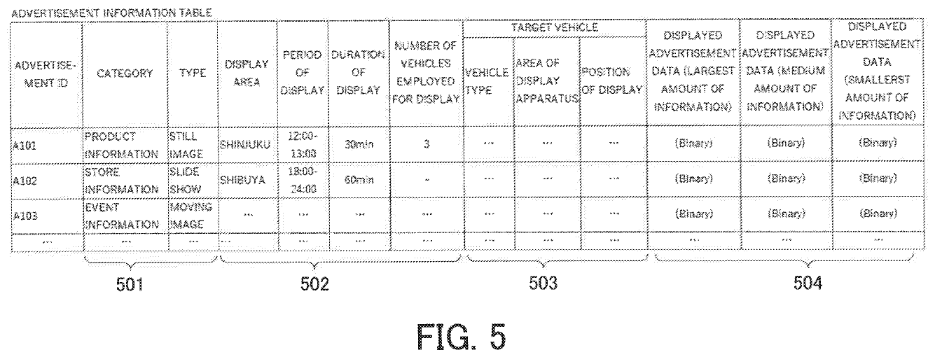

Data stored in the advertisement information database 202A will now be described with reference to FIG. 5. FIG. 5 illustrates an example of the content of an advertisement information table stored in the advertisement information database 202A. As illustrated, the information stored in the advertisement information table includes identification data of the advertisement (advertisement ID), information relating to properties of the advertisement (501), information relating to conditions for display of the advertisement (502), information designating a vehicle to be employed to display the advertisement (503), and data to be output to the display apparatus 101 of the vehicle (displayed advertisement data 504).

The displayed advertisement data may be, for example, still image data, consecutive image data, or moving image data. Each displayed advertisement data includes a plurality of versions of data that have different amounts of information, according to this embodiment.

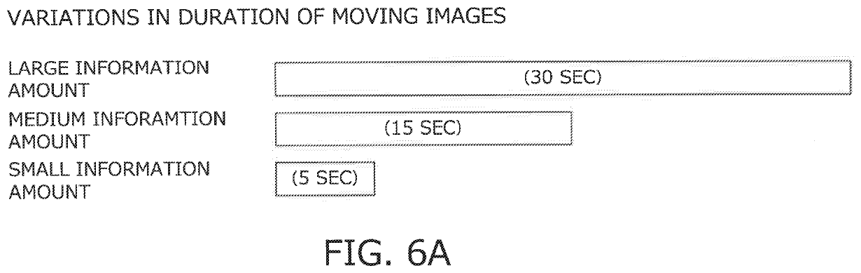

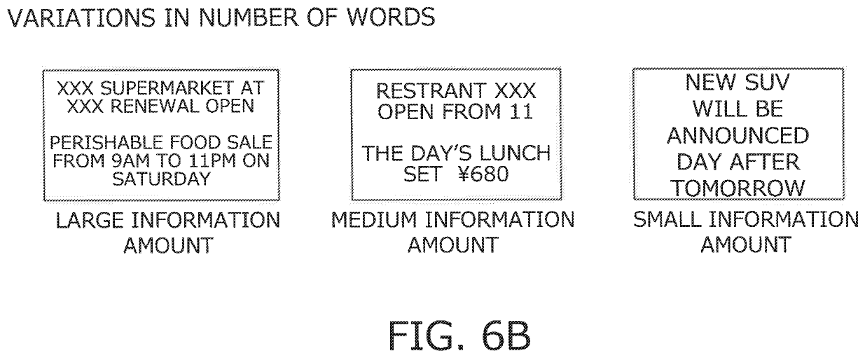

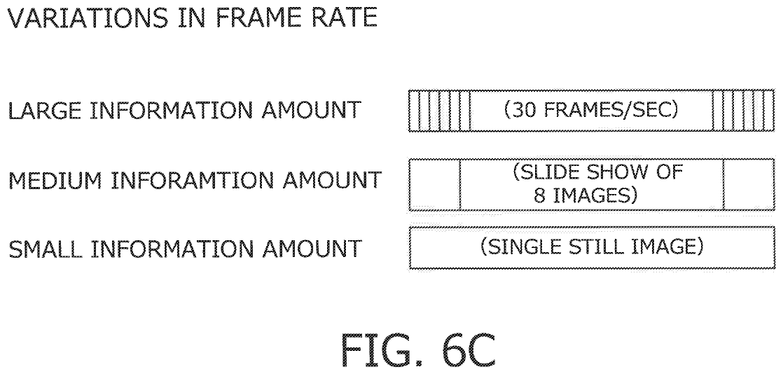

In the following, variations in the amount of information will be described. Examples of variations in the amount of information among a plurality of versions of data are as follows, as illustrated in FIG. 6.

Example 1: variations in the duration of moving images in accordance with variations (large, medium, and small) in the amount of information
large: a long version moving image (30 seconds)
medium: a normal version moving image (15 seconds)
small: a short version moving image (5 seconds)

Example 2: variations in the number of words appearing in still or moving images in accordance with variations (large, medium, and small) in the amount of information
large: a still or moving image containing about 30 words
medium: a still or moving image containing about 20 words
small: a still or moving image containing about 10 words

Example 3: variations in the frame rate of advertisement in accordance with variations (large, medium, and small) in the amount of information
large: a moving image
medium: a slide show of images
small: a still image

The variations given above are merely examples. A plurality of versions of displayed advertisement data may be varied in the amount of information in other manners. The amount of information may be the amount of information per unit time. Alternatively, the amount of information may be the number of images displayed per unit time or the number of words appearing per unit time. While three versions having different amounts of information (namely, large, medium, and small) are prepared in this embodiment, the number of variations in the amount of information may be more than three. Alternatively, the amount of information may be varied in a continuous manner. For example, the vehicle 10 may execute the processing of decreasing the amount of information of a single version of displayed advertisement data.

Each data stored in the advertisement information database 202A will be referred to as “advertisement data”.

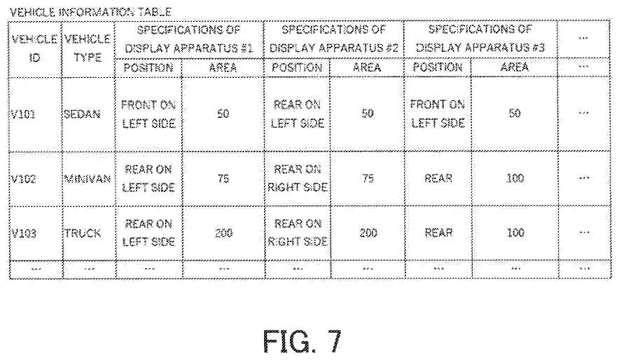

Next, data stored in the vehicle information database 202B will be described with reference to FIG. 7. FIG. 7 illustrates an example of the content of a vehicle information table stored in the vehicle information database 202B. The information stored in the vehicle information table includes information about the type of the vehicle and information about the display apparatus. Examples of the information about the display apparatus include, but are not limited to, the number of display apparatuses, the positions at which the display apparatuses are provided, and the area of each display.

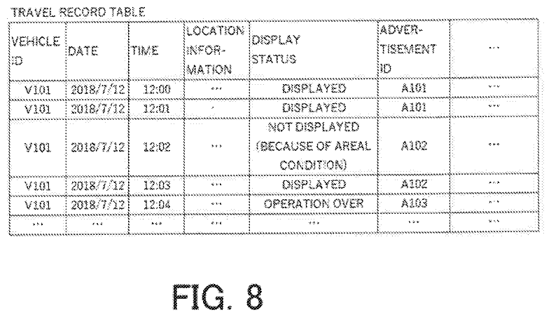

Data stored in the travel record database 202C will be described with reference to FIG. 8. FIG. 8 illustrates an example of the content of a travel record table stored in the travel record database 202C. Information stored in the travel record table includes identification data of the vehicle (vehicle ID), date and time, location information (e.g. latitude and longitude) of the vehicle 10, the status of display of advertisement, identification data of the advertisement displayed at the time (advertisement ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031, a vehicle management part 2032 and a report making part 2033. These three functional modules may be implemented by executing programs stored in auxiliary storage by the CPU.

The advertisement distribution part 2031 determines an advertisement to be displayed by a designated vehicle 10 and sends corresponding advertisement data to the vehicle 10.

The vehicle management part 2032 periodically communicates with the vehicles 10 to collect location information of the vehicles 10 and identification data of the respective advertisements displayed by the vehicles 10 and updates the travel record database 202C.

The control unit 203 further includes a report making part 2033, which makes a report on an advertisement and billing data based on the result recorded in the travel record database 202C.

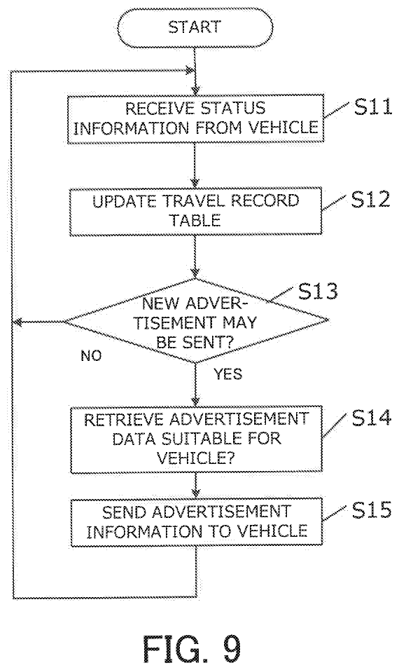

Next, we will describe how the advertisement distribution system according to the embodiment distributes advertisements to the vehicles 10 to cause them to display the advertisements. FIG. 9 is a flow chart of a process executed by the server apparatus 20. The server apparatus 20 executes the process according to the flow chart in FIG. 9 periodically (or every unit time) for each of the vehicles 10 under its management.

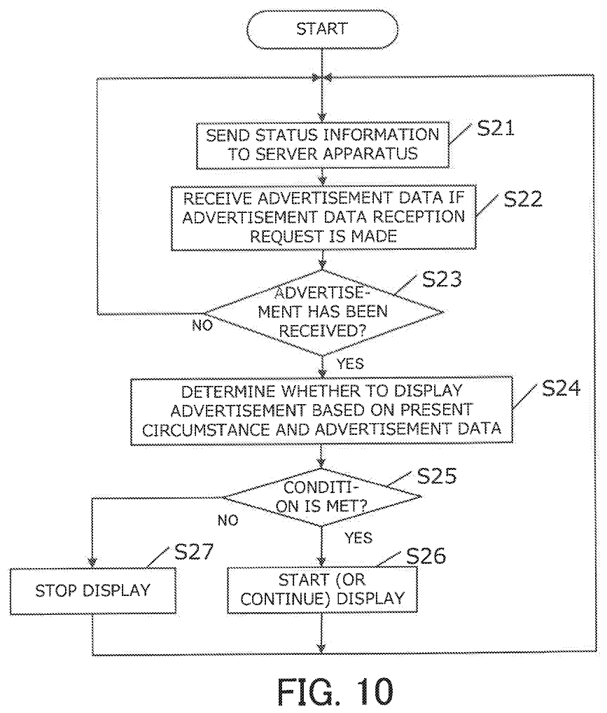

Firstly in step S11, the server apparatus 20 receives status information from the vehicles 10 under its management. The status information includes information about the present location of each vehicle, the identification data of the presently displayed advertisement, and the status of display of advertisement. In this step, specifically, the vehicle management part 2032 sends an inquiry to each of the vehicles 10 (specifically, the informing part 1023 thereof). In response to the inquiry, the informing part 1023 of each vehicle 10 sends location information acquired by the location information acquisition unit 105, information about whether or not there is an advertisement presently on display (with the ID of the advertisement, if affirmative), and the status of display of advertisement as the status information. Details of the processing performed by the vehicle 10 will be described later with reference to FIG. 10.

While in the system according to the embodiment the server apparatus 20 periodically sends an inquiry to the vehicles 10, each vehicle 10 may periodically send the aforementioned information to the server apparatus 20 by push communication alternatively. In this alternative case, the processing of step S11 is not necessarily executed at the timing indicated in FIG. 9.

Then in step S12, the server apparatus 20 updates the travel record table based on the status information received from the vehicle 10. Specifically, the vehicle management part 2032 adds a record including the vehicle ID, date, time, location information, display status, and displayed advertisement ID (if an advertisement is on display) to the travel record table stored in the travel record database 202C.

Then in step S13, it is determined whether or not new advertisement data may be sent to the subject vehicle 10 (namely, the vehicle for which this process is being performed). If a negative determination is made in step S13, the process proceeds to step S11, and the subject of the process is changed to another vehicle 10.

Whether or not new advertisement data may be sent to a certain vehicle 10 can be determined by whether or not the properties of the vehicle 10 satisfy the condition set for each advertisement. For example, in the case where a condition relating to the vehicle type and the display apparatus of the vehicle (like data 503 in FIG. 5) is set, whether or not new advertisement data may be sent to a certain vehicle 10 is determined by whether or not the properties of the vehicle 10 meet this condition.

Alternatively, whether or not advertisement data may be sent to a certain vehicle 10 may be determined by consulting information about the vehicle 10. For example, in the case where the vehicle 10 is a contract driver's vehicle, information about the preference of the owner of the vehicle 10 may be stored in the vehicle information table, and an advertisement to be distributed to the vehicle 10 may be determined using this information.

If there is an advertisement for which the subject vehicle 10 meets the condition, information relating to the advertisement is retrieved (in step S14) and sent to the vehicle 10 (step S15).

Even when it is determined that advertisement data may be sent to the vehicle 10, there may be cases where the advertisement data is not sent for the reason that a certain condition relating to the vehicle is not met. For example, the reception of advertisement data may be rejected by the vehicle 10 in some circumstances.

The above-described process is executed repeatedly for every vehicle 10 under the management of the server apparatus 20.

Next, the process executed by the vehicle 10 will be described. The process executed by the vehicle 10 can be divided into two processes. A first process is the process of sending and receiving data relating to advertisement to and from the server apparatus 20 and starting and stopping display of an advertisement. A second process is the process of changing the amount of information of the displayed advertisement.

FIG. 10 is a flow chart of the first process executed by the vehicle 10. This process is executed by the vehicle 10 at the time when the inquiry from the server apparatus 20 is received.

Firstly, in step S21, the informing part 1023 sends the following information to the server apparatus 20:

(1) location information acquired by the location information acquisition unit 105

(2) the presence/absence of displayed advertisement (with its ID, if present)

(3) the status of display of advertisement

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of steps S21 is not necessarily executed at the timing indicated in FIG. 10.

Then, in step S22, it is determined whether or not reception of advertisement data is requested by the server apparatus 20, and if it is requested, the vehicle 10 receives the advertisement data.

Then, in step S23 it is determined whether or not the advertisement outputting part 1022 has already received the advertisement data from the server apparatus 20. If a negative determination is made in step S23 (i.e. the vehicle 10 has no advertisement data), the process returns to step S21. If an affirmative determination is made in step S23, the process proceeds to step S24, where it is determined whether or not the advertisement is to be displayed on the basis of comparison between the present circumstance and the condition set in the advertisement data the vehicle 10 has received.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S24 indicates that the condition is met (Yes in step S25), the process proceeds to step S26, where display of the advertisement is started (or continued, if the advertisement has already been displayed). If data of a plurality of advertisements are stored in the vehicle 10, the advertisement to be displayed may be selected according to a certain condition.

If the condition is not met (No in Step S25), the process proceeds to step S27, where display of the advertisement is ended.

In step 27, it may be determined whether or not display of the advertisement is to be ended. For example, in the case where a total display time is designated for a certain advertisement, if the total display time of the advertisement has elapsed, it is determined that display of this advertisement is to be ended. Furthermore, if the operation (or travel) of the vehicle 10 that displays a certain advertisement ends (e.g. if the ignition is turned off), it is determined that display of the advertisement is to be ended. After display of an advertisement is ended, the advertisement data for this advertisement may be deleted.

The vehicle 10 displays the advertisement by the above process.

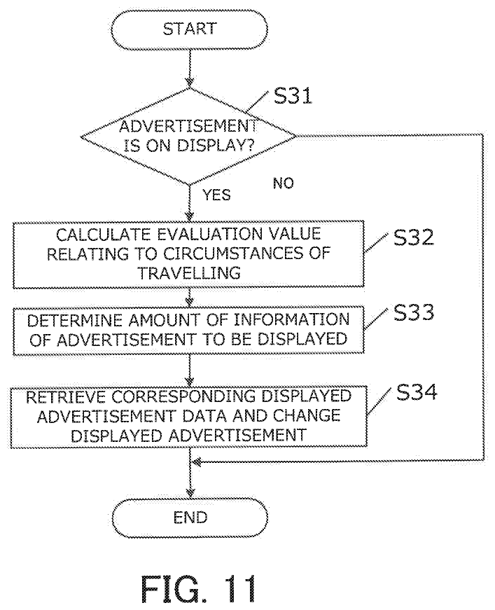

Next, the second process executed by the vehicle 10 will be described with reference to FIG. 11. This process is executed by the control unit 102 periodically while the vehicle 10 is travelling.

Firstly, in step S31, it is determined whether or not an advertisement is presently being displayed. If no advertisement is being displayed, the process is ended. Then, the process is not executed until the start of the next cycle.

If an advertisement is being displayed, then in step S32 the travel circumstances acquiring part 1024 calculates an evaluation value relating to the circumstances of travelling on the basis of information acquired through the sensor 106. The evaluation value relating to the circumstances of travelling in this embodiment is a numerical value representing the speed or average speed of the vehicle 10 or a factor(s) that affects the speed or average speed.

Examples of the evaluation value are as follows.

(1) the average speed of the vehicle 10

The average speed of the vehicle 10 over a predetermined length of time (e.g. one, three, five, or ten minutes) may be calculated and used as an evaluation value. The average speed may be calculated from sensor data obtained from the vehicle speed sensor.

(2) the amount of traffic in the vicinity of the vehicle 10

For example, the amount of traffic (e.g. the amount of traffic per unit time) on the road (or road link) that the vehicle 10 is travelling may be determined and used as an evaluation value. The amount of traffic may be determined, for example, based on the result of sensing of other vehicles (by e.g. a vehicle distance sensor) or the result of communication with other vehicles. Alternatively, the amount of traffic may be obtained from another apparatus (e.g. an apparatus provided at roadside) that can determine the amount of traffic.

(3) the average speed of other vehicles located in the vicinity of the vehicle 10

For example, the average speed (e.g. the average speed over a predetermined length of time) of vehicles on the road (or road link) that the vehicle 10 is travelling may be determined and used as an evaluation value. The average speed may be determined, for example, based on the result of sensing of other vehicles (e.g. the result of sensing of relative positions thereof) or the result of communication with other vehicles. Alternatively, the average speed may be obtained from another apparatus (e.g. an apparatus provided at roadside) that can determine the average speed.

Both the average speed and the amount of traffic may be used as evaluation values.

(4) status of a traffic signal present ahead of the vehicle 10

Whether the vehicle 10 is to stop or not depends on the indication of the traffic signal ahead of the vehicle 10. Therefore, a value representing the status of the traffic signal that is located within a predetermined distance ahead of the vehicle 10 can serve as an evaluation value.

The status of a traffic signal may be represented by the indication of the traffic signal or a point in the signal cycle (e.g. the remaining time of the present indication or the time elapsed since the last change in the indication). The indication of a traffic signal may be determined using an image captured by an on-vehicle camera included in the sensor 106, or information about the indication may be obtained by communicating with a roadside apparatus that controls the traffic signal.

The evaluation value calculated in step S32 is not limited those described above, but it may be any value that is relevant to the visibility of the displayed advertisement.

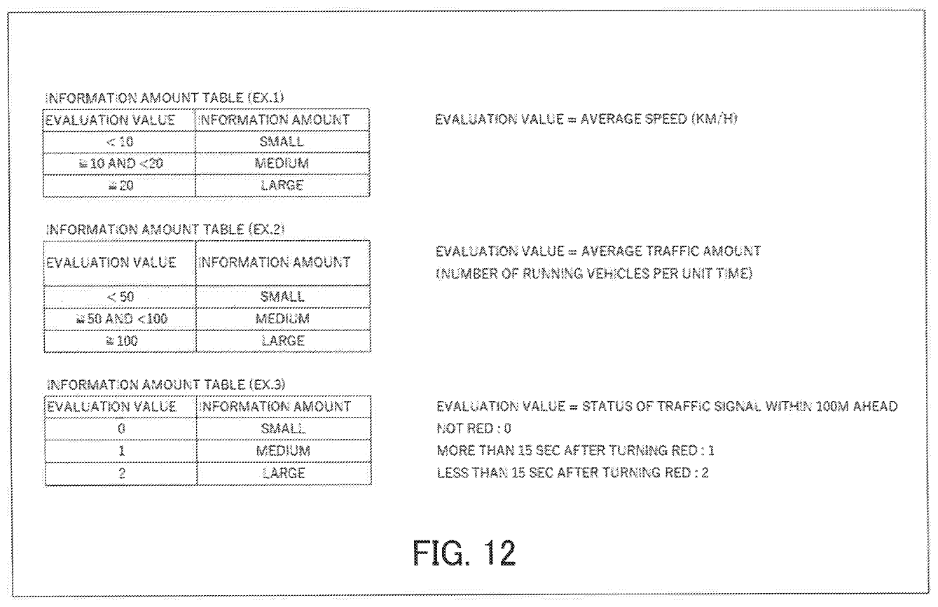

Then, in step S33, the amount of information of the advertisement to be displayed is determined on the basis of the evaluation value calculated as above. While in the system according to this embodiment there are three variations (namely, large, medium, and small) in the amount of information of advertisement as illustrated in FIGS. 6A to 6C, there may be any number of variations in the amount of information, as long as it is possible to set correspondence between evaluation values and amounts of information. The amount of information may be varied continuously. The correspondence between the evaluation values and the amounts of information may be prepared in advance as a table or a mathematical expression and stored in the storage. Examples of such a table (information amount table) are shown in FIG. 12.

Then, in step S34, displayed advertisement data corresponding to the amount of information determined in step S33 is retrieved, and the displayed advertisement is replaced using the retrieved data. Thus, the content of the advertisement is changed to one that is suitable for the circumstances of travelling of the vehicle 10. The subject of the advertisement displayed after the change may be either the same as or different from that of the advertisement displayed before the change. In the former case, the advertisement displayed after the change is another version of advertisement about the same thing.

As above, the advertisement distribution system according to the first embodiment obtains information about the circumstances of travelling of the vehicle 10 that displays an advertisement and selects an advertisement that has an amount of information suitable for the circumstances of travelling. Thus, it can display an advertisement having a content suitable for the visibility of the advertisement. For example, when the vehicle 10 is expected to stop at a red light, a long moving image of advertising may be displayed, and when vehicle is travelling, a short moving image of advertising may be displayed.

(Modification of First Embodiment)

The above embodiment is only for the illustrative purpose. Appropriate modifications can be made thereto without departing from the essence of the present disclosure.

For example, in the above description of the embodiment, it is assumed that the same advertising content is output to all of the plurality of display apparatuses. However, different advertisement contents may be output to different display apparatuses alternatively. In this alternative case, the process according to the flow chart in FIG. 11 may be executed for each of the display apparatuses. In this case, different principles of determining the amount of information may be applied to different display apparatuses.

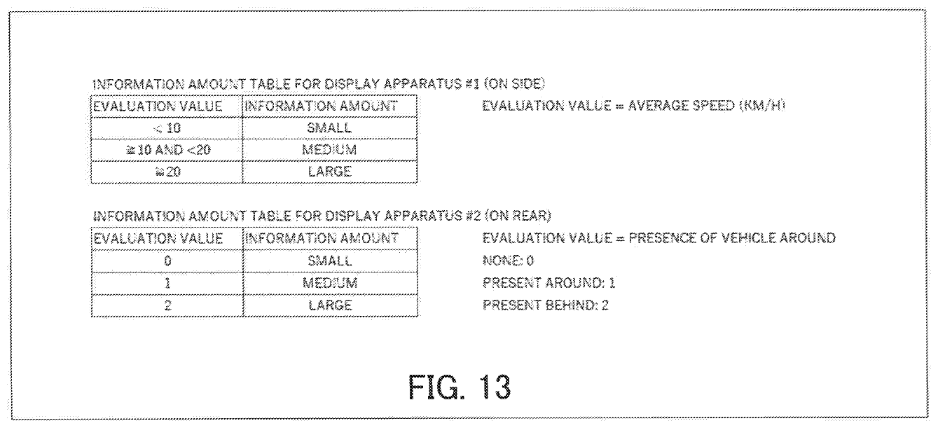

FIG. 13 shows different information amount tables applied to different display apparatuses. In this illustrative case, the amount of information is controlled on the basis of the average speed in the case of advertisements displayed on a display apparatus provided on a side of the vehicle 10 and on the basis of the presence of other vehicles around the vehicle 10 in the case of advertisements displayed on a display apparatus provided on the rear of the vehicle 10.

This system can output, for example, an advertisement with a large amount of information on the rear display apparatus when there is another vehicle behind, even while the vehicle 10 is travelling.

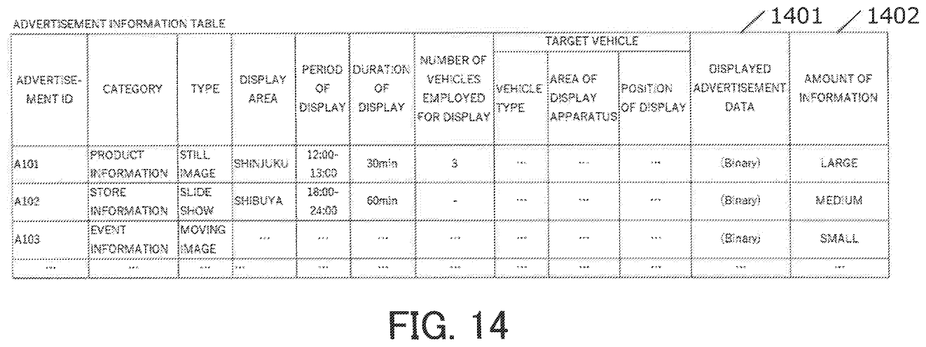

In the above-described system according to the first embodiment, a plurality of pieces of displayed advertisement data that have different amounts of information (data 504 in FIG. 5) are prepared for the same advertisement. However, it is not essential to prepare a plurality of pieces of displayed advertisement data. For example, as shown in FIG. 14, only a single piece of displayed advertisement data (1401) may be prepared for each advertisement. In this case, appropriate advertisement data having an appropriate amount of information may be selected by consulting the information amount field (1402).

(Other Modifications)

The processing and units that have been described in the foregoing may be employed in any combinations so long as it is technically feasible to do so.

For example, although the process of changing amount of information of the display apparatus is executed by the vehicle 10 in the above-described system according to the embodiment, the process according to the flow chart in FIG. 11 may be executed by the server apparatus 20 alternatively. In this alternative case, the process according to the flow chart in FIG. 11 may be incorporated in the process according to the flow chart in FIG. 9.

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present disclosure can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus comprising a control unit configured to execute the processing of:
acquiring information relating to the circumstances of travelling of a vehicle that is capable of outputting an advertisement by a display apparatus arranged to face outward;
determining the amount of information of the advertisement to be output on the basis of the circumstances of travelling; and
selecting the advertisement to be output to the display apparatus on the basis of the amount of information thus determined.

2. An information processing apparatus according to claim 1, wherein
the circumstances of travelling include at least one of the speed of the vehicle, the presence of another vehicle in the vicinity of the vehicle, and the length of time over which the vehicle is expected to stop in a certain period of time.

3. An information processing apparatus according to claim 1, wherein
the advertisement comprises a moving image, and the control unit determines the amount of information of the moving image to be output per unit time on the basis of the circumstances of travelling.

4. An information processing apparatus according to claim 1, wherein
the advertisement comprises a moving image, and the control unit determines the duration of the moving image to be output on the basis of the circumstances of travelling.

5. An information processing apparatus according to claim 1, wherein
the advertisement comprises a still image, and the control unit determines the number of words contained in the still image to be output.

6. An information processing method comprising the following steps executed by an information processing apparatus:
acquiring information relating to the circumstances of travelling of a vehicle that is capable of outputting an advertisement by a display apparatus arranged to face outward;
determining the amount of information of the advertisement to be output on the basis of the circumstances of travelling; and
selecting the advertisement to be output to the display apparatus on the basis of the amount of information thus determined.

7. A non-transitory computer readable storage medium storing a computer program for causing a computer to execute the processing of:
acquiring information relating to the circumstances of travelling of a vehicle that is capable of outputting an advertisement by a display apparatus arranged to face outward;
determining the amount of information of the advertisement to be output on the basis of the circumstances of travelling; and
selecting the advertisement to be output to the display apparatus on the basis of the amount of information thus determined.
